(19) United States
(12) Patent Application Publication
(10) Pub. No.: US 2026/0360038 A1
(43) Pub. Date: Nov. 12, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Noriko TAKAGI, Kanagawa (JP)

(21) Appl. No.: 19/407,033

(22) Filed: Dec. 3, 2025

(30) Foreign Application Priority Data
Dec. 17, 2024 (JP) 2024-220979

(51) Int. Cl. G06T 11/60

(52) U.S. Cl. CPC G06T 11/60

(57) ABSTRACT

A problem is that in a case where a generative AI is requested to generate a decorated character image, there is a case where decoration of such a level that a character based on which the decorated character image is generated cannot be deciphered is added. A technique of the present disclosure analyzes whether a decorated character image generated by a generative AI based on a prompt containing an input character string received from a user can be deciphered. Then, based on a result of the analysis, a decorated character image from which the input character string can be deciphered is outputted.

### BACKGROUND

### Field of the Technology

The present disclosure relates to a technique of generating a decorated character by using a generative AI.

### Description of the Related Art

In recent years, a user's favorable decorated character is generated by using a generative AI for any character designated by the user. Examples of decorated characters include ligatures in which a plurality of characters are combined to represent one character, and swashes which are design character forms in which solid lines of characters at the beginning and the end of a word are extended. Although a decorated character appears to be difficult to read because of the applied decoration, it is important that the decorated character can be correctly recognized as a character. Japanese Patent Laid-Open No. 2007-79979 discloses a technique of obtaining character codes of decorated characters such as shadowed characters by performing OCR processing on the characters in the case of converting electronic documents generated by various pieces of application software into a predetermined format to centrally manage the electronic documents.

### SUMMARY

An information processing apparatus according to the present disclosure has: one or more memories storing instructions; and one or more processors executing the instructions to: receive designation of an input character string from a user; obtain a decorated character image which is generated by a generative AI based on a prompt containing the received input character string, and a result of analysis processing of determining whether or not the input character string can be deciphered from the decorated character image; and output, based on the obtained result of the analysis processing, the decorated character image which is generated by the generative AI and for which it is determined that the input character string can be deciphered from the decorated character image.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram showing an example of an overall configuration of a content creation system;

FIG. 2 is a diagram showing an example of a hardware configuration of an information processing apparatus;

FIG. 3 is a flowchart showing an operation flow of a content editing server according to Embodiment 1;

FIGS. 4A to 4D are diagrams showing examples of layout editing screens;

FIG. 5 is a diagram showing an example of a deciphering level setting screen;

FIGS. 6A to 6E are diagrams showing examples of decorated character images;

FIG. 7 is a flowchart showing an operation flow of a content editing server according to Embodiment 2; and

FIG. 8 is a diagram showing an example of a use permission setting screen.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

In advertising media such as posters and leaflets, decorated characters are often used in order to visually make an impact and deliver information such as the names of shops and the concepts of products and services of the shops. Normally, in considering a decorated character to be used in a poster or the like, the user performs, for decorated character candidates, works such as confirmation and selection of whether the decorated character is suitable and favorable for the user's image (design). Here, decorated characters generated by a generative AI sometimes include those which are at a level that cannot be deciphered for humans. In the case where a decorated character which cannot be deciphered by humans is used in advertising media, the original purpose of delivering information cannot be achieved. In the case of causing a generative AI to generate candidate decorated characters, it is also necessary for the user to determine whether a decorated character presented by the generative AI is at a level that can be deciphered in the first place in addition to the above-described confirmation and selection, which increases the time and effort of the user.

### First Embodiment

### <System Configuration>

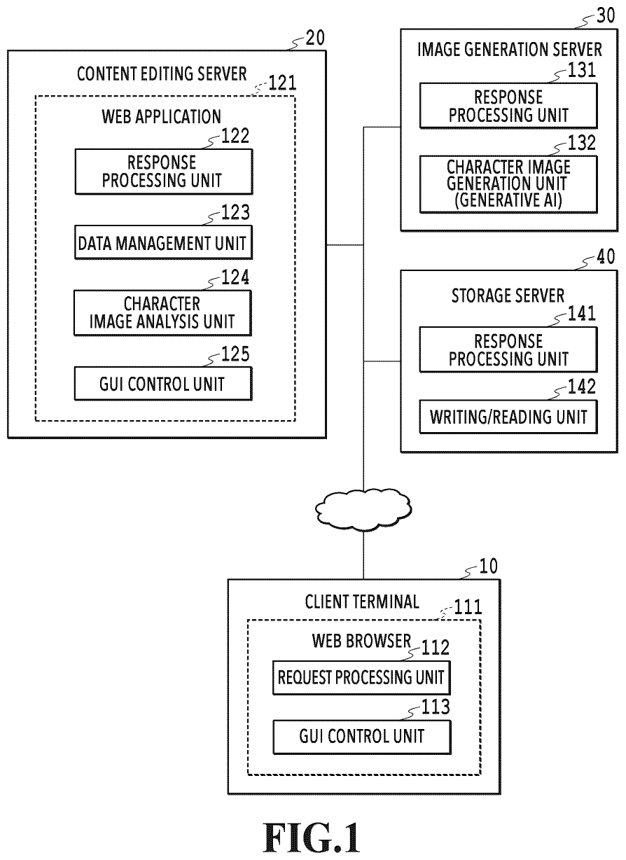

FIG. 1 is a diagram showing an example of an overall configuration of a content creation system according to the present embodiment, as well as functional configurations of a client terminal 10 and servers 20 to 40 for providing cloud services, which are components of the system. The content creation system shown in FIG. 1 is configured with a client terminal 10, a content editing server 20, an image generation server 30, and a storage server 40. The content editing server 20 of the present embodiment provides a cloud service which creates a content by laying out objects such as a text, an image, and a figure on a design template (hereinafter, simply referred to as a “template”). The user can create a content such as a poster, a leaflet, or a photo album by accessing the content editing server 20 from the client terminal 10, and laying out, in a template which the user has selected, a text using decorated characters generated by a generative AI as an object.

The client terminal 10 and the servers 20 to 40 communicate with one another via a network. Although the network will be described by giving the Internet as an example, the network may be, for example, LAN such as an intranet, WAN, a wireless communication network, a telephone line, a dedicated digital line, an ATM, or the like. In addition, the network may be a communication network achieved by any combination of these. In the content creation system shown in FIG. 1, there are three servers 20 to 40 corresponding to the respective services to be provided, a server configuration which is achieved by a plurality of information processing apparatuses sharing the functions of the content editing server 20, for example, may be employed. Alternatively, such a configuration in which one server provides a plurality of services like a configuration in which the content editing server 20 also functions as the image generation server 30 may be employed, for example.

### <<Overview of Client Terminal>>

The client terminal 10 is an information processing apparatus having a web browser 111, such as a laptop PC, a smartphone, or a tablet terminal. The web browser 111 is software for browsing a website on the Internet, and using a content creation service provided by the content editing server 20. The web browser 111 receives a client program from a web application 121, for providing the service, of the content editing server 20, and interprets a script language such as HTML or JavaScript to provide the content creation service. In addition, the web browser 111 can also cause a printing apparatus, which is not shown, to print a design content such as a poster, which is received from the web application 121, in accordance with an instruction of the user. The web browser 111 has a request processing unit 112 and a GUI control unit 113. The request processing unit 112 requests the content editing server 20 to generate a design content and to generate a decorated character used in the design content, for example, and conducts processing to receive a product generated in accordance with the request. The GUI control unit 113 controls a GUI (graphical user interface) corresponding to the web application 121 on a display of a user interface 201. The user makes an instruction to the web application 121 by performing operations such as input and selection of a character or the like by using an input apparatus such as a keyboard or a mouse, while looking at various UI screens displayed on the display.

### <<Overview of Content Editing Server>>

The content editing server 20 is an information processing apparatus having the web application 121 for the user to generate a design content such as a poster, a leaflet, or a photo album. The web application 121 is configured with a response processing unit 122, a data management unit 123, a character image analysis unit 124, and a GUI control unit 125.

The response processing unit 122 receives a user instruction from the client terminal 10, and performs response processing in accordance with the received user instruction. For example, in the case where the received instruction is a search instruction for a template of a design content such as a poster or a leaflet, the response processing unit 122 accesses the storage server 40, and obtains a template according to the search instruction from among templates held by the storage server 40. The user can designate search conditions for the template by inputting a text or selecting a template image in a template search screen generated by the GUI control unit 125, which will be described later, and displayed on the web browser 111. In addition, for example, in the case where the received instruction is a generation request for a decorated character, the response processing unit 122 transmits a generation request for a decorated character image to the image generation server 30, and receives the decorated character image, which is a product, from the image generation server 30, and transfer the decorated character image to the client terminal 10. In addition, the response processing unit 122 transmits, to the client terminal 10, a content containing a desired decorated character, which is created based on a user instruction from the client terminal 10.

The data management unit 123 stores, in the storage server 40, information on a layout in the case where the user edited a desired template on the web browser, data of a decorated character image generated by the generative AI, and the like in association with the user.

The character image analysis unit 124 performs analysis processing on a decorated character image generated by the generative AI to determine whether or not a character string based on which the decorated character image is generated can be deciphered. In this analysis processing, for example, a learned model obtained by training using pairs of various decorated character images and their correct answer data (corresponding character strings) as learning data is used. Specifically, the character image analysis unit 124 obtains a result of decipherability by inputting, into the learned model, a decorated character image of a processing target and a prompt of instructing analysis on whether the decorated character image can be deciphered to such an extent that satisfies a predetermined deciphering level. In addition, as the analysis processing, for example, the character image analysis unit 124 may perform processing of performing OCR (Optical Character Recognition) processing on a decorated character image of a processing target, and determining whether a recognition character string and a character string based on which the decorated character image is generated match each other. In this case, the character image analysis unit 124 may execute the OCR processing after performing a publicly-known image processing technique such as a layout analysis or region extraction of the decorated character image. Moreover, the character image analysis unit 124 may execute both of an approach using a learned model and an approach using OCR processing and take logical disjunction (OR operation) or logical conjunction (AND operation) of results of both analyses. The character image analysis unit 124 executes such analysis processing by using resources in the content editing server 20 or by requesting a dedicated external server (not shown) to perform all or part of the analysis processing.

The GUI control unit 125 generates various UI screens such as a home screen, a template search screen, a layout editing screen, and an error message screen in accordance with a URL designated by the user via the web browser 111, and displays the UI screens on the web browser 111 via the response processing unit 122.

### <<Overview of Image Generation Server>>

The image generation server 30 is an information processing apparatus which provides an image generation service using a generative AI, and is configured with a response processing unit 131 and a character image generation unit (generative AI) 132.

The response processing unit 131 receives a generation request from the content editing server 20, and performs response processing of transmitting, to the content editing server 20, data of a decorated character image generated in accordance with the received generation request. The generative AI 132 is a generative AI which generates a decorated character image and the like by using a prompt as an input. As the image generative AI, for example, “Copilot” can be used, but the image generative AI is not limited to this, and may be another image generative AI. The generative AI 132 is achieved by a learned model (content creation model) obtained by performing machine learning with various data through an approach such as deep learning so as to obtain a target content.

### <<Overview of Storage Server>>

The storage server 40 is an information processing apparatus which provide storage ⋅ management services for various data and setting information to be used ⋅ generated by the web application 121, and is configured with a response processing unit 141 and a writing/reading unit 142.

The response processing unit 141 receives a request for storing data or obtaining data from the content editing server 20, the image generation server 30, or the client terminal 10, and performs response processing in accordance with the received request. The writing/reading unit 142 performs processing of writing and holding data in a large-capacity storage medium such as an HDD, which is not shown, and reading data held therein, based on an instruction of the response processing unit 141. Specifically, the writing/reading unit 142 writes or reads various template images, template images edited by the user, a file indicating layouts of objects in template images, decorated character images generated by the generative AI, information on the user, and the like.

### <Hardware Configuration>

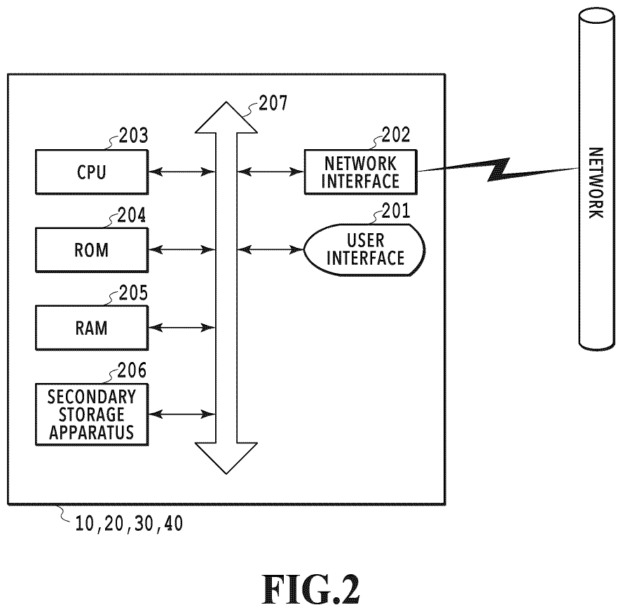

FIG. 2 is a diagram showing an example of a hardware configuration of an information processing apparatus which is common among the client terminal 10 and the servers 20 to 40. A user interface 201 is an operation displaying unit which is configured with a display, a keyboard, a mouse, a button, a touch panel, and the like, and performs input and output of information and signals. A network interface 202 is connected to a network such as LAN, and communicates with another computer or network device. The system of the communication may be wired or wireless. A CPU 203 is a central computation processing apparatus which executes programs read from a ROM 204, a RAM 205, a secondary storage apparatus 206, or the like. The ROM 204 is a non-volatile memory in which incorporated programs and data have been recorded. The RAM 205 is a volatile memory which provide a temporal memory area. The secondary storage apparatus 206 is a large-capacity storage apparatus represented by an HDD or a flash memory. A computer that does not include these pieces of hardware can be connected and operated from another computer by means of a remote desktop or a remote shell. These units are connected via an input-output interface 207.

### <Operation Flow of Content Editing Server>

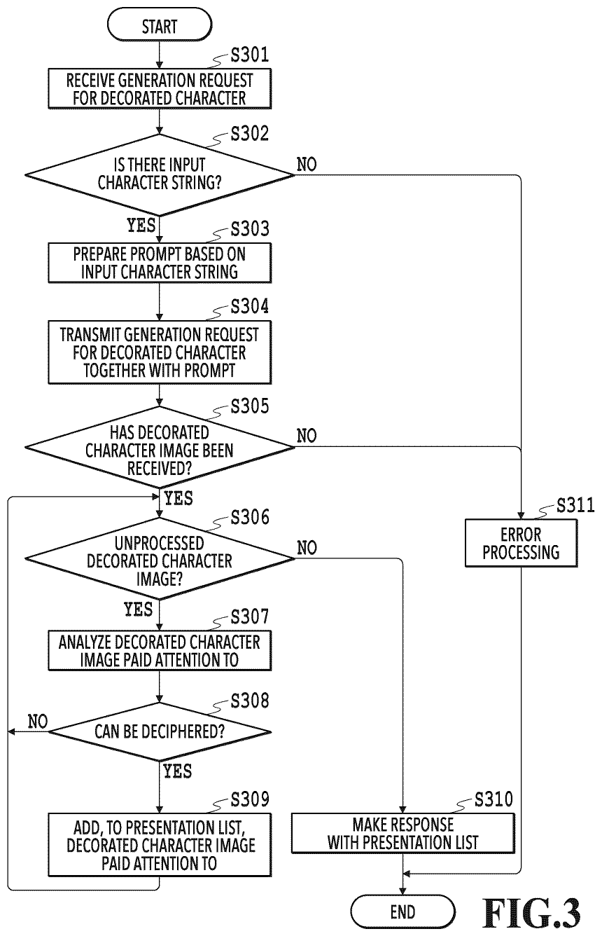

Subsequently, a flow of processing of presenting, to a user, those which can be deciphered among decorated character images generated by the generative AI 132, which is a feature of the present embodiment, among processings executed by the content editing server 20 will be described with reference to a flowchart of FIG. 3. The execution of the series of the processings shown in the flowchart of FIG. 3 is started by the user selecting a desired template on a UI screen (not shown) for creating a poster, which is displayed on the client terminal 10 by the web browser 111. Note that in the following description, sign “S” means a step.

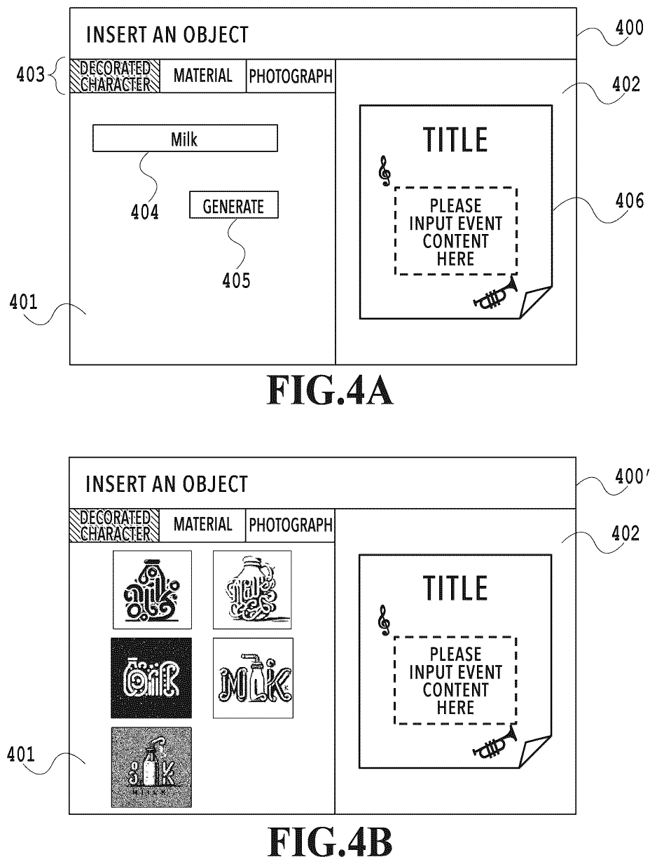

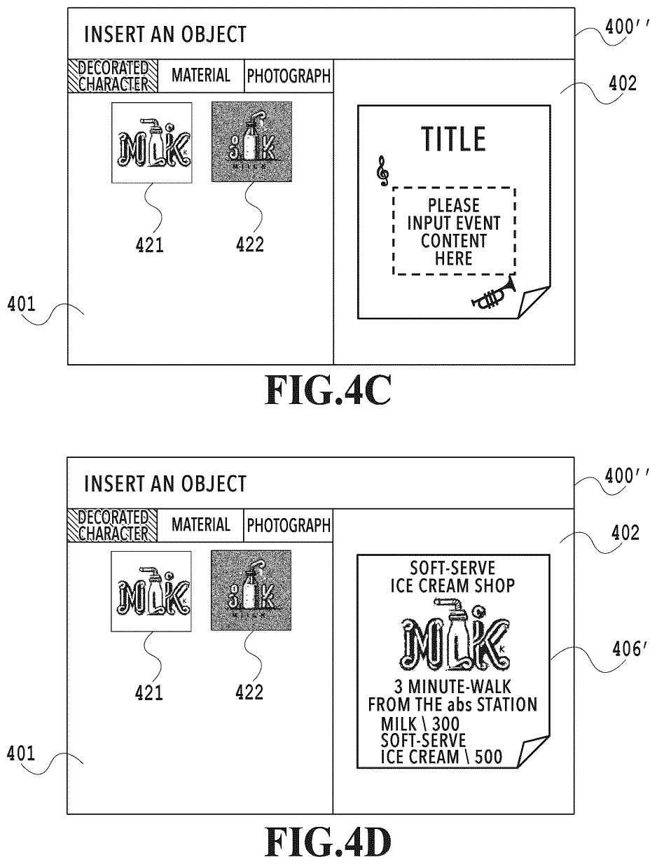

In S301, the response processing unit 122 receives a generation request for a decorated character from the client terminal 10. FIG. 4A is a diagram showing an example of a layout editing screen which is a UI screen for arranging a desired object on a template according to the user's selection. This layout editing screen is generated by the GUI control unit 125 of the web application 121 as mentioned above, and is obtained by the web browser 111 and displayed by the GUI control unit 113. The user can instruct the generative AI 132 to generate a decorated character image by inputting a character string which the user wants to express with decorated characters into a text box 404 in a left pane 401 of a layout editing screen 400 of FIG. 4A, and pressing down a generation button 405. In addition, in an upper portion of the left pane 401, there are tabs 403 corresponding to the types of a target object which is to be laid out on the template designated by the user. A decorated character tab is a tab for instructing generation of a desired decorated character image, a material tab is a tab for searching for and generating a desired material, and a photograph tab is a tab for selecting and designating a desired photograph. By switching these tabs, an operation region corresponding to the type of a target object is displayed below the tabs. In a right pane 402 of the layout editing screen 400, a template 406 which is selected by the user on the template search screen, which is not shown, is displayed. The user can create a design content such as a poster by arranging an object retrieved, generated, designated, or performing a thing like these under the selected tab onto the template 406 by drag and drop using a mouse, for example. In the case where the decorated character tab is selected in the layout editing screen 400 of FIG. 4A, first, an empty text box 404 and a generation button 405 are displayed. As mentioned above, the user inputs a character string which the user wants to express with decorated characters into the text box 404, and presses down the “Generate” button 405. Then, the request processing unit 112 of the web browser 111 transmits, to the content editing server 20, information on the inputted character string (hereinafter, referred to as an “input character string”) and a generation request for a decorated character image based on this input character string. In the present step, this generation request is received by the response processing unit 122. Note that now, in the text box 404 of FIG. 4A, a character string “Milk” has been inputted, and the case of generating a decorated character image of “Milk” will be described below as an example.

In S302, processing to be executed next is switched depending on whether or not the input character string according to the generation request received by the response processing unit 122 in S301 has an entity (that is, whether the input character string is not empty). If the input character string is empty, S311 is executed next. On the other hand, if the input character string is not empty, S303 is executed next.

In S303, the response processing unit 122 prepares a prompt for causing the generative AI 132 to execute generation of a decorated character image of the input character string according to the generation request received in S301. Here, the prompt is a directive for designating, to the generative AI, a direction as to what content should be generated. It is necessary for the prompt to include specific information so that the generative AI can correctly understand and process the content of the instruction. In view of this, in the present embodiment, a prompt containing the input character string itself such as “Please create a ligature font of “Milk””, for example, is prepared. Here, as an approach for preparing a prompt, for example, several prompt samples may be held in the storage server 40 and combined with input character strings to prepare a prompt. Alternatively, a generative AI dedicated to preparing a prompt may be used. Alternatively, images/photographs or the like of various logos may be prepared in advance such that in the case where the user inputs a character string and subsequently selects a specific logo image, a prompt based on the taste of the logo image is prepared, for example. For example, in the case where base colors of a logo image selected by the user are red and white, a prompt like “Please create a ligature font of “Milk” based on red and white” is prepared. Moreover, a configuration that allows the user to designate a desired color through a palette selection, and a prompt based on a specific color is prepared may be employed.

In S304, the response processing unit 122 transmits, to the image generation server 30, a generation request for a decorated character image together with the prompt prepared in S303. Upon receipt of this generation request, a decorated character image according to the prompt is generated in the generative AI 132 in the image generation server 30, and the response processing unit 122 receives data of the generated decorated character image.

In S305, processing to be executed next is switched depending on whether the response processing unit 122 has received the data of the decorated character image corresponding to the transmitted generation request. If the decorated character image has been received, S306 is executed next. On the other hand, if the decorated character image has not been received, S311 is executed next.

In S306, processing to be executed next is switched depending on whether or not the analysis processing for all the received decorated character images has been completed. If there is a decorated character image for which the analysis processing has not been performed yet, S307 is executed next. On the other hand, if the analysis processing has been performed for all the received decorated character images, S310 is executed next.

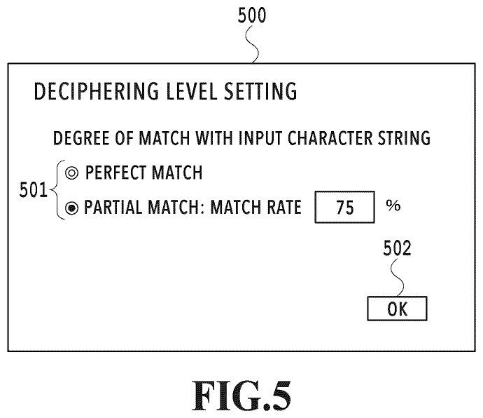

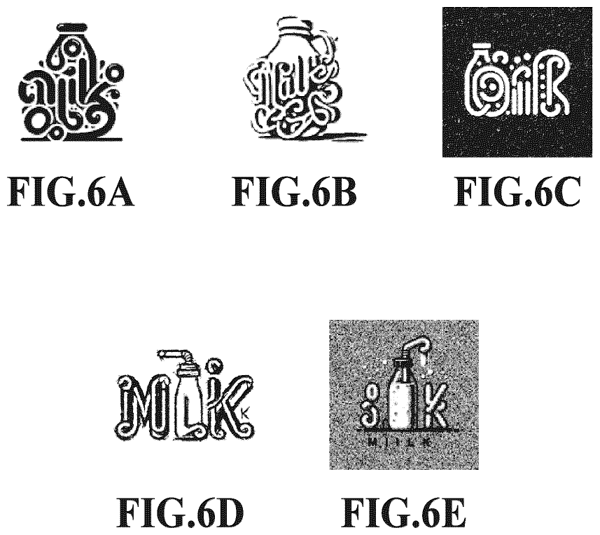

In S307, regarding a decorated character image paid attention to among the received decorated character images, the character image analysis unit 124 performs processing of analyzing whether or not the input character string based on which the decorated character image is generated can be deciphered in accordance with a deciphering level set in advance. FIG. 5 is an example of a UI screen (deciphering level setting screen) for the user to set the deciphering level to be referred to by the character image analysis unit 124 in the analysis processing. In a region 501 of a deciphering level setting screen 500 shown in FIG. 5, the user sets a reference on how much the degree of match between a character string extracted from each decorated character image and the input character string based on which the decorated character image is generated is required for determining that the input character string can be deciphered. In the present embodiment, the user selects either “PERFECT MATCH” or “PARTIAL MATCH” by using radio buttons. Then, in the case where the user selects “PARTIAL MATCH”, the user further designates a desired match rate in percentage. The user performs operations of selecting and designating the deciphering level in consideration of experimental rules such as, for example, an experimental rule that there is a high probability that lower-case alphabet “1” is falsely recognized as number “1”, for example, a priority of design, and the like, and after the completion of these operations, presses down an OK button 502. Here, in the present embodiment, it is assumed that a difference between a capital letter and a lower-case letter of an alphabet does not affect the result (that is, even in the case where the input character string is alphabet “M”, and a character string (recognition character string) extracted from a target decorated character image for the analysis processing is “m”, it is determined that they “match”). Now, in the deciphering level setting screen 500 of FIG. 5, “partial match” is selected, and “75%” is designated as the match rate. In this case, if the match rate between the character string extracted from a decorated character image and the input character string based on which the decorated character image is generated is 75% or more, it is determined that the input character string can be deciphered. FIGS. 6A to 6E show examples of decorated character images generated by the generative AI using the above-mentioned prompt “Please create a ligature font of “Milk”” as an input. In the case of decorated character images of FIGS. 6A to 6C, it is difficult to extract each character of “Milk” which is composed of four characters of alphabet from the general viewpoint. However, regarding a decorated character image of FIG. 6D, character strings of “MLK” which is composed of three characters of alphabet can be extracted, which means that three characters can be deciphered out of “Milk”, which is composed of four characters. In addition, regarding a decorated character image of FIG. 6E, a character string of “MIILK” which is composed of five characters of alphabet can be extracted, which means that three characters can be deciphered out of “Milk”, which is composed of four characters. That is, in the case where “partial match” and match rate “75%” are set as the deciphering level, the decorated character images of FIGS. 6D and 6E are such that three characters match out of the total four characters, and the match rates are 75%, and it is determined that the input character string can be deciphered. Note that although in the above-mentioned examples, the sufficiency of the match rate is judged in accordance with whether or not each character which configures the input character string appears, the match rate with the input character string may be determined in consideration of factors such as the number and the order of arrangement of recognized characters, for example.

In S308, processing to be executed next is switched depending on the result of the above-mentioned analysis processing on the character string image paid attention to in S307. As the result of the analysis processing, if it is determined that the input character string can be deciphered, S309 is executed next. On the other hand, if it is determined that the input character string cannot be deciphered, the processing returns to S306, and is continued.

In S309, the character image analysis unit 124 adds a character string image paid attention to, to a list (hereinafter, referred to as a “presentation list”) for presenting generated decorated character images to the user. Specifically, the character image analysis unit 124 instructs, via the response processing unit 122, the storage server 40 to store data of the decorated character image paid attention to and the presentation list to which the decorated character image has been added. Upon this instruction, in the storage server 40, the writing/reading unit 142 stores the data of the character string image paid attention to and the presentation list to which the character string image has been added. The presentation list prepared in this way holds information as shown in Table 1 given below, for example.

TABLE 1

| Index | value |
|---|---|
| Input Text | Milk |
| Response | The input character string “Milk” can be deciphered from the |
| | images in the list. The match rate with the input character |
| | string is 75%. |
| Path | \storage_server\decochar\001.jpg |
| | \storage_server\decochar\002.jpg |

In the case of Table 1 mentioned above, in item “Input Text”, the input character string used in generation of the decorated character image is stored as an item value. In addition, in item “Response”, information indicating the result of the analysis processing is stored. In addition, in item “Path”, information of paths in the storage server 40, which are the storage destinations of the data of the decorated character images, is stored. Note that in the example of Table 1 mentioned above, a plurality of values can be written in item “Path”; however, item “Path” may be managed by, for example, a key value-type approach which holds a value of “Path” as a different data structure. Once the character string image paid attention to is added to the presentation list, the processing returns to S306, and is continued.

In the case where the analysis processing on all the received decorated character images has been completed, in S310, the response processing unit 122 makes a response with the presentation list. That is, the response processing unit 122 transmits the presentation list obtained in the processing so far to the client terminal 10, which is the transmission source of the generation request for decorated character images, and instructs the client terminal 10 to display the images contained in the presentation list on the layout editing screen. In the client terminal 10 which has received the presentation list together with this instruction, the GUI control unit 113 obtains data of the decorated character images designated in the presentation list through access to the storage server 40, or the like, and displays the decorated character images on the layout editing screen.

In S311, error processing is executed. Specifically, processing in which, for example, the GUI control unit 125 prepares an error message screen or the like which urges input or retry of a character string, and the response processing unit 122 transmits the error message screen or the like to the client terminal 10 is performed as the error processing. Upon this, in the client terminal 10, the GUI control unit 113 executes display processing of performing pop-up display or the like of the received error message screen or the like. The operation flow of the content editing server 20 according to the present embodiment is as described above.

### <Confirmation of Decorated Character Image in Client Terminal>

Here, with reference to the drawings, how decorated character images based on a presentation list are presented to the user on the web browser 111 of the client terminal 10 will be described by using the aforementioned specific example.

First, for comparison, the case of the conventional technique will be described with reference to FIG. 4B. In the case of a layout editing screen 400′ shown in FIG. 4B, all character string images (five decorated character images shown in aforementioned FIGS. 6A to 6E) generated by the generative AI 132 based on the input character string “Milk” are displayed in the left pane 401. The user who has looked at such a layout editing screen needs to determine whether the input character string can be deciphered for each of the plurality of displayed decorated character images, before or simultaneously in parallel with searching for a decorated character image which matches the user's preference. This is a work which takes time and effort for the user, and also, the larger the number of displayed decorated character images is, the longer the time taken for the determination is.

Next, the case of the approach according to the present embodiment will be described with reference to FIG. 4C. In the case of a layout editing screen 400″ shown in FIG. 4C, only character string images included in a presentation list among all character string images generated by the generative AI 132 based on the input character string “Milk” are displayed in the left pane 401. That is, among the five decorated character images shown in FIGS. 6A to 6E, only two decorated character images, that is, a decorated character image 421 corresponding to FIG. 6D and a decorated character image 422 corresponding to FIG. 6E, for which it is determined that the input character string can be deciphered are presented to the user. In the case of the layout editing screen 400″ shown in FIG. 4C, since there is no need to pay attention to whether or not the input character string can be deciphered, the user can concentrate on the work of selecting a decorated character image which matches the user's preference, as compared with the layout editing screen 400′ shown in FIG. 4B. FIG. 4D shows a state in which the user selected the decorated character image 421 and arranged the decorated character image 421 on the template 406 in the right pane 402 in the layout editing screen 400″ shown in FIG. 4C. In this way, the user can create a desired design content by performing editing operations such as further arranging another object.

### <Modification Example>

In the above-mentioned embodiment, among decorated character images generated by the generation A, those which satisfy the deciphering level set in advance are stored in the storage server 40. However, the configuration is not limited to this. In general, it is said that an image generated by a generative AI has no reproducibility (it is difficult to generate completely the same image as the first generated image, as the second generated image). In view of this, the following configuration may be employed. Specifically, those which do not satisfy the deciphering level may also be stored in the storage server 40. Then, for example, in the case where the user could not find a satisfactory decorated character image from among those presented, analysis processing in which the deciphering level is lowered is executed based on a request of the user, on all the stored decorated character images. Then, those which satisfy the lowered deciphering level are presented. Alternatively, only data of decorated character images laid out on a template by the user may be stored.

In addition, in the above-mentioned embodiment, among decorated character images generated by the generative AI, those which satisfy the deciphering level are listed, and presented to the user. However, the following configuration may be employed. Specifically, the minimum number of decorated character images to be included in a list is specified, for example. Then, in the case where the number of decorated character images which satisfy the deciphering level does not reach a constant number, the processing is returned to S304, and the processing of causing the generative AI to generate a decorated character image is repeatedly performed, to ensure that decorated character images the number of which exceeds the constant number can be presented to the user.

In addition, in the above-mentioned embodiment, a presentation list which allows those which satisfy the deciphering level among decorated character image generated by the generative AI to be specified is prepared, and presented to the user, and data of the listed decorated character images is stored in the storage server 40. However, the configuration is not limited to this. For example, the following configuration may be employed. Specifically, a presentation list containing data of decorated character images which are determined to satisfy the deciphering level is prepared, and transmitted to the client terminal 10. In this case, every time it is determined that a decorated character image can be deciphered in S308, a presentation list containing data of the decorated character image paid attention to is updated in S309, and the presentation list is stored in the RAM 205 or the secondary storage apparatus 206 in the content editing server 20.

In addition, in the above-mentioned embodiment, an aspect in which a decorated character image is generated by the generative AI via the web application on the server which provides the content editing service has been described. However, the configuration is not limited to this. For example, an aspect in which that a decorated character image is generated by a generative AI via an application which is installed in the client terminal 10 may be employed.

As described above, according to the present embodiment, only those which can be deciphered among decorated character images generated by the generative AI are presented to the user. For this reason, since the user does not need to determine, by the user's own, whether the input character string can be deciphered for each of the decorated character images presented, the user can concentrate on the works of check and selection on which decorated character image is suitable for a design content such as a poster, which the user is creating.

### Second Embodiment

In the case of a general generative AI, it is often the case that the upper limit for the number of uses by which the generative AI can be used within a certain period of time is set in association with the user. In this case, the user for whom the number of uses of the generative AI has reached the upper limit cannot cause the generative AI to generate a desired decorated character image to create a design content until the next certain period of time. An aspect in which a decorated character image generated by the other users are allowed to be used in the case where the user cannot receive the service of providing a decorated character image by a generative AI due to a reason where the number of uses of the generative AI has exceeded an upper limit, or the like in this way will be described as Embodiment 2.

### <Operation Flow of Content Editing Server>

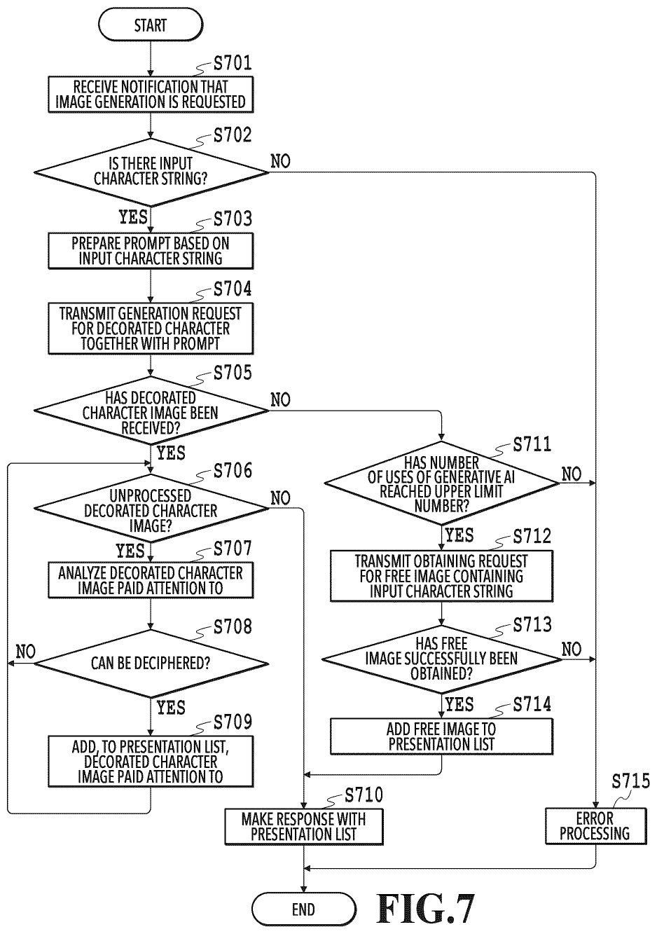

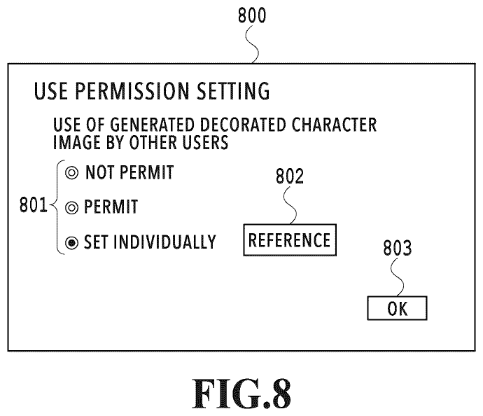

Since the system configuration and the like are common with Embodiment 1, the description thereof will be omitted, and an operation flow of a content editing server which is a difference from Embodiment 1 will be mainly described. FIG. 7 is a flowchart showing a flow of an operation of a content editing server 20 in the present embodiment, which corresponds to the flowchart of FIG. 3 of Embodiment 1. Before executing the series of processings shown in the present flowchart, for example, each user may be prompted to indicate the user's intention as to whether to permit the other users to freely use a decorated character image generated by the each user. Specifically, each user who causes the generative AI to generate a decorated character image via a web browser 111 is asked to set whether to permit the other users to freely use the decorated character image via a predetermined UI screen. FIG. 8 is an example of a UI screen (use permission setting screen) for a user to set whether or not to permit the other users to freely use a decorated character image generated by the user. In a region 801 of a use permission setting screen 800 shown in FIG. 8, the user selects, by using a radio button, one of “Not permit thoroughly”, “Permit thoroughly”, and “Set individually” as to whether to permit the other users to freely use a decorated character image generated by the user. Then, in the case where the user has selected “Set individually”, the user presses down a reference button 802 and designates whether or not free use is permitted for each individual decorated character image. Then, once the user presses down an OK button 803, attribute information according to the selected radio button is added to each decorated character image generated by the generative AI based on the request of this user, and data of the decorated character image is stored in the storage server 40. Table 2 given below shows an example in which to an individual decorated character image, a flag (flag value “1”=Usable, “0”=NG) representing whether or not to permit free use is added as attribute information.

TABLE 2

| | | Use |
|---|---|---|
| | | Permission |
| Index | Value | Flag |
| Input Text | Milk | N/A |
| Response | The input character string “Milk” can be | N/A |
| | deciphered from the images in the list. The | |
| | match rate with the input character string is | |
| | 75%. | |
| Path | \storage_server\decochar\001.jpg | 1 (OK) |
| | \storage_server\decochar\002.jpg | 0 (NG) |

The case of the example of above Table 2 means that the other users can freely use the decorated character image of “001.jpg”, but the other users cannot freely use the decorated character image of “002.jpg”.

Hereinafter, the flow of the operation of the content editing server 20 according to the present embodiment will be described with reference to the flowchart of FIG. 7. As in the case of the flow of aforementioned FIG. 3, the execution of the series of processings shown in the flow of FIG. 7 is also started by the user selecting a desired template on a UI screen (not shown) for creating a poster, which is displayed on the client terminal 10 by the web browser 111. Note that in the following description, sign “S” means a step.

S701 to S704 correspond respectively to S301 to S304 in the flow of FIG. 3 of Embodiment 1, and there are no particular differences, and thus, the description thereof is omitted. In S705, if the response processing unit 122 has received data of a decorated character image corresponding to the transmitted generation request, S706 is executed next, and if not, S711 is executed next. S706 to S710 correspond respectively to S306 to S310 in the flow of FIG. 3 of Embodiment 1, and there are no particular differences, and thus, the description thereof is omitted.

In S711, processing to be executed next is switched depending on whether or not the cause for which the response processing unit 122 has not received a decorated character image is that the number of uses of the generative AI by the user who is currently using the generative AI has exceeded an upper limit number. If the cause for which a decorated character image has not been received is that the number of uses of the generative AI has reached the upper limit number and a decorated character image has not been generated, S712 is executed next. On the other hand, if the cause for which a decorated character image has not been received is not that the number of uses has been reached the upper limit number, but for another cause, S715 is executed next.

In S712, the response processing unit 122 accesses the storage server 40, and transmits an obtaining request for a decorated character image whose free use by the other users is permitted (hereinafter, referred to as a “free image”). Upon receipt of this obtaining request, the response processing unit 141 of the storage server 40 refers to an input character string, which is a value of “Input Text” in the aforementioned Table 2, and attribute information (use permission flag) to search for data of a decorated character image whose degree of match with the input character string satisfies the aforementioned deciphering level. Then, the response processing unit 141 of the storage server 40 obtains, via the writing/reading unit 142, the data of the decorated character image thus found, and returns the data of the decorated character image to the content editing server 20.

In S713, processing to be executed next is switched depending on whether the response processing unit 122 has obtained data of a free image from the storage server 40. If the response processing unit 122 has obtained one or more free images, S714 is executed next. On the other hand, if the response processing unit 122 has not obtained one or more free images, S715 is executed next.

In S714, the response processing unit 122 adds the obtained one or more free images to the aforementioned presentation list. That is, the response processing unit 122 instructs the storage server 40 to store data of the one or more free images and the presentation list to which the free images have been added. In this event, information such as a flag indicating that the images are free images may be added in the presentation list. After execution of S714, in S710, a response with the presentation list is made.

In S715, error processing is executed. Specifically, for example, processing in which the GUI control unit 125 prepares a message screen which urges input or retry of a character string, or a message screen which indicates that there is no usable free image, or the like, and the response processing unit 122 transmits the message screen to the client terminal 10 is performed. Upon this, in the client terminal 10, the GUI control unit 113 executes display processing of pop-up display or the like of the received message screen or the like.

The operation flow of the content editing server 20 according to the present embodiment is as described above. In this way, even in the case where the user who is currently using the generative AI cannot cause the generative AI to generate a decorated character image for some reason, in S710 after S711 to S714, it becomes possible for the response processing unit 122 to return a presentation list in which a free image is included.

### <Modification Example>

Note that in the case where a decorated character image has not been received because the number of uses of the generative AI has reached the upper limit number (Yes in S711), the user may be asked whether the user desires to use a free image before the processing proceeds to S712. Specifically, for example, By displaying a message screen that “Since the number of uses of the generative AI has reached the upper limit, a decorated character image cannot be generated. Would you like to use a decorated character image generated by another user in the past?” or the like on the web browser 111, or performing another measure, the intention of the user is checked. Then, only in the case where the user's intention that the user wants to use a free image is confirmed, S712 may be executed. In this event, if there is a reply that the user will not use a free image, for example, an error message screen that “After waiting for a while, please try again.” or the like may be displayed in S715.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, the time and effort of the user for determining decipherability of a decorated character presented by a generative AI can be omitted.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-220979, filed Dec. 17, 2024 which is hereby incorporated by reference herein in its entirety.

What is claimed is:

1. An information processing apparatus comprising:
one or more memories storing instructions; and
one or more processors executing the instructions to:
receive an input character string from a user;
obtain a decorated character image which is generated by a generative AI based on a prompt containing the received input character string, and a result of analysis processing of determining whether or not the input character string can be deciphered from the decorated character image; and
output, based on the obtained result of the analysis processing, the decorated character image which is generated by the generative AI and for which it is determined that the input character string can be deciphered from the decorated character image.

2. The information processing apparatus according to claim 1, wherein based on the obtained result of the analysis processing, the decorated character image which is generated by the generative AI and for which it is determined that the input character string cannot be deciphered from the decorated character image is not outputted.

3. The information processing apparatus according to claim 1, wherein
the result of the analysis processing is obtained by
obtaining the decorated character image which is generated by the generative AI, and
performing the analysis processing on the obtained decorated character image.

4. The information processing apparatus according to claim 3, wherein
the one or more processors further execute the instructions to: receive designation of a deciphering level of the input character string in the analysis processing, and
the analysis processing is performed based on the designated deciphering level.

5. The information processing apparatus according to claim 4, wherein the deciphering level is a degree of match between a character string extracted from the decorated character image which is generated by the generative AI and the input character string.

6. The information processing apparatus according to claim 5, wherein the degree of match includes a perfect match between the extracted character string and the input character string, and a partial match between the extracted character string and the input character string.

7. The information processing apparatus according to claim 6, wherein in a case where the partial match is designated as the deciphering level, the one or more processors further execute the instructions to: receive designation of a match rate.

8. The information processing apparatus according to claim 4, wherein the analysis processing is processing of determining whether or not the deciphering level is satisfied, by using a learned model which is obtained by training using, as learning data, a pair of a decorated character image and correct answer data for the decorated character image.

9. The information processing apparatus according to claim 4, wherein the analysis processing is processing of determining whether or not the deciphering level is satisfied, by comparing a recognition character string which is obtained by performing OCR (Optical Character Recognition) processing on the decorated character image which is generated by the generative AI, and the input character string based on which the decorated character image is generated.

10. The information processing apparatus according to claim 1, wherein
the one or more processors further execute the instructions to:
prepare a list of the decorated character image which is generated by the generative AI and for which it is determined that the input character string can be deciphered from the decorated character image, and
output the list to an external apparatus which has been used by the user for the designation of the input character string.

11. The information processing apparatus according to claim 10, wherein
the one or more processors further execute the instructions to: output, to an external apparatus which stores data, data of the decorated character image which is generated by the generative AI, and
the list contains information indicating a storage destination of data of the decorated character image included in the list.

12. The information processing apparatus according to claim 11, wherein the one or more processors further execute the instructions to: output, to an external apparatus which stores data, data of the decorated character image which is generated by the generative AI and for which it is determined that the input character string can be deciphered from the decorated character image.

13. The information processing apparatus according to claim 1, wherein
the one or more processors further execute the instructions to:
prepare the prompt containing the received input character string; and
cause, based on the prepared prompt, an external apparatus which provides an image generation service using the generative AI to generate a decorated character image obtained by decorating the received input character string, and receive a product of the generation.

14. The information processing apparatus according to claim 11, wherein
in the external apparatus which stores data, past data of a decorated character image which is generated by the generative AI is stored, and
in a case where the decorated character image which is generated by the generative AI using, as an input, the prompt containing the received input character string is not obtained, the list is prepared by obtaining data of a decorated character image from which the input character string can be deciphered, among the past data.

15. The information processing apparatus according to claim 14, wherein the case where the decorated character image which is generated by the generative AI using, as the input, the prompt containing the received input character string is not obtained is a case where the number of uses of the generative AI by the user has exceeded an upper limit.

16. The information processing apparatus according to claim 14, wherein the past data is data of the decorated character image which is generated by the generative AI based on an instruction of another user and whose free use is permitted by the other user.

17. An information processing method comprising:
receiving designation of an input character string from a user;
obtaining a decorated character image which is generated by a generative AI based on a prompt containing the received input character string, and a result of analysis processing of determining whether or not the input character string can be deciphered from the decorated character image; and
outputting, based on the obtained result of the analysis processing, the decorated character image which is generated by the generative AI and for which it is determined that the input character string can be deciphered from the decorated character image.

18. A non-transitory computer readable storage medium storing a program for causing a computer to perform an information processing method comprising:
receiving designation of an input character string from a user;
obtaining a decorated character image which is generated by a generative AI based on a prompt containing the received input character string, and a result of analysis processing of determining whether or not the input character string can be deciphered from the decorated character image; and
outputting, based on the obtained result of the analysis processing, the decorated character image which is generated by the generative AI and for which it is determined that the input character string can be deciphered from the decorated character image.
